(19) United States
(12) Patent Application Publication
(10) Pub. No.: US 2011/0153446 A1
(43) Pub. Date: Jun. 23, 2011

(54) METHODS AND APPARATUS FOR APPLYING AUCTIION BIDS TOWARDS THE PURCHASE OF AN ITEM

(76) Inventors: Ralph Werner, Berlin (DE); Frank Han, Menlo Park, CA (US)

(21) Appl. No.: 12/640,664

(22) Filed: Dec. 17, 2009

(51) Int. Cl. G06Q 30/00

(52) U.S. Cl. 705/26.3

(57) ABSTRACT

In some embodiments, a processor-readable medium stores code representing instructions configured to cause a processor to receive a first signal indicating that a first user has used a first bid to bid on a first item at an auction, and increase an auction price of the first item in response to receiving the first signal. The processor-readable medium further stores code representing instructions configured to cause a processor to receive a second signal indicating that a second user has used a second bid to bid on the first item at the auction, increase the auction price of the first item in response to receiving the second signal and receive a third signal indicating that the first user has chosen to purchase a second item substantially similar to the first item for a discounted price. The discounted price is equal to a retail price of the second item minus at least a price of the first bid.

### RELATED APPLICATIONS

This application is related to co-pending U.S. patent application Ser. No. 11/421,100, filed on May 31, 2006, and entitled “Process for Automatic Determination of an End Value,” and co-pending U.S. patent application Ser. No. 11/768,364, filed on Jun. 26, 2007, and entitled “Method for the Automatic Determination of an End Value,” each of which is incorporated herein by reference in its entirety.

### BACKGROUND

Embodiments described herein relate generally to auctions and more particularly to applying auction bids towards the purchase of an item.

Various forms of auctions are known. Such known auctions allow users to bid on an item for a predetermined amount of time. Once the predetermined amount of time elapses, the bidder who bids the highest amount is awarded the item. In many known auctions the highest bidder is also the final bidder in the auction. The other participants in the auction do not have the opportunity to purchase a similar item and do not receive anything for casting bids in the auction. If the bidders not awarded the item wish to purchase a similar item, they can bid in another auction or pay full price for the similar item at a retailer. If the auction requires a participant to purchase the bids cast in the auction, the cost of the bids is lost to the user and the user does not receive anything for purchasing the bids. Thus, in such known auctions a user who is not awarded the item in the auction does not gain anything by participating in the auction.

Accordingly, a need exists for methods and apparatus that provides a bidder who is not awarded the auctioned item in an auction with a method of using any cost of bids that is lost to the user.

### SUMMARY

In some embodiments, a processor-readable medium stores code representing instructions configured to cause a processor to receive a first signal indicating that a first user has used a first bid to bid on a first item at an auction, and increase an auction price of the first item in response to receiving the first signal. The processor-readable medium further stores code representing instructions configured to cause a processor to receive a second signal indicating that a second user has used a second bid to bid on the first item at the auction, increase the auction price of the first item in response to receiving the second signal and receive a third signal indicating that the first user has chosen to purchase a second item substantially similar to the first item for a discounted price. The discounted price is equal to a retail price of the second item minus at least a price of the first bid.

### BRIEF DESCRIPTION OF THE DRAWINGS

FIG. 1 is a schematic diagram that illustrates communication devices in communication with a host device via a network, according to an embodiment.

FIG. 2 is a flow chart illustrating a method of managing an auction, according to another embodiment.

FIGS. 3 and 4 are tables illustrating an example of an auction, according to another embodiment.

FIG. 5 is a table illustrating an example of an auction, according to another embodiment.

FIG. 6 is a flow chart illustrating a method of managing an auction, according to another embodiment.

### DETAILED DESCRIPTION

In some embodiments, a processor-readable medium stores code representing instructions configured to cause a processor to receive a first signal indicating that a first user has used a first bid to bid on a first item at an auction, and increase an auction price of the first item in response to receiving the first signal. The processor-readable medium further stores code representing instructions configured to cause a processor to receive a second signal indicating that a second user has used a second bid to bid on the first item at the auction, increase the auction price of the first item in response to receiving the second signal, and receive a third signal indicating that the first user has chosen to purchase a second item substantially similar to the first item for a discounted price. The discounted price is equal to a retail price of the second item minus at least a price of the first bid.

In some embodiments, the discounted price can be equal to the retail price of the second item minus the total price of all of the bids used by the first user in the auction. As described in further detail herein, for example, if a user uses five bids in an auction and each of the five bids costs $1.00, the discounted price of the second item would be $5.00 less than the retail price of the second item. This allows a user who was not awarded the item in the auction to apply the costs associated with bidding in the auction to the purchase of a substantially similar item.

In some embodiments, a method includes receiving a first signal indicating that a first user has provided an indication to purchase a first bid. A second signal indicating that the first user has provided an indication to use the first bid to bid on a first item at an auction is received and a first auction price of the first item is stored in a memory in response to receiving the second signal. A third signal indicating that a second user has provided an indication to use a second bid to bid on the first item at the auction is received and a second auction price of the first item is stored in the memory in response to receiving the third signal. A fourth signal indicating that the first user has provided an indication to purchase a second item substantially similar to the first item for a discounted price is received. The discounted price is equal to a retail price of the second item minus at least a price of the first bid. The first item is awarded to the second user for the second auction price of the first item if a fifth signal indicating that the first user or a third user has provided an indication to use a third bid on the first item is not received in a predetermined amount of time.

As used in this specification, the singular forms “a,” “an” and “the” include plural referents unless the context clearly dictates otherwise. Thus, for example, the term “a communication device” is intended to mean a single communication device or multiple communication devices; and “network” is intended to mean one or more networks, or a combination thereof.

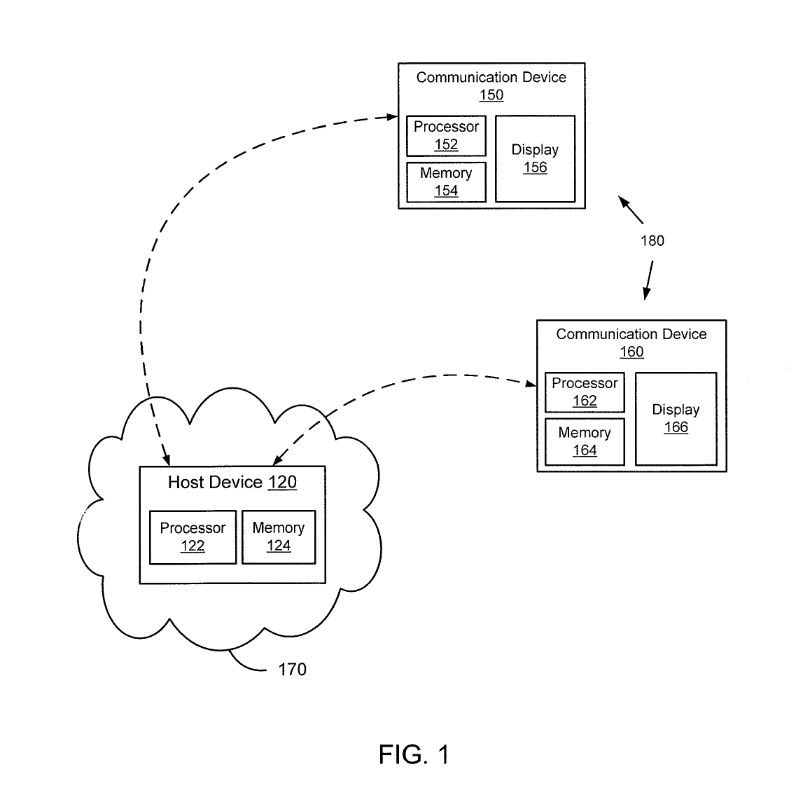

FIG. 1 is a schematic diagram that illustrates communication devices 180 in communication with a host device 120 via a network 170, according to an embodiment. Specifically, communication device 150 is configured to communicate with the host device 120. Similarly, communication device 160 is configured to communicate with the host device 120. The network 170 can be any type of network (e.g., a local area network (LAN), a wide area network (WAN), a virtual network, a telecommunications network) implemented as a wired network and/or wireless network. As described in further detail herein, in some embodiments, for example, the communication devices 180 are personal computers connected to the host device 120 via an internet service provider (ISP) and the Internet (e.g., network 170).

The host device 120 can be any type of device configured to send data over the network 170 to and/or receive data from one or more of the communication devices 180. In some embodiments, the host device 120 can be configured to function as, for example, a server device (e.g., a web server device), a network management device, and/or so forth.

The host device 120 includes a memory 124 and a processor 122. The memory 124 can be, for example, a random access memory (RAM), a memory buffer, a hard drive, and/or so forth. In some embodiments, the memory 124 of the host device 120 includes data used to facilitate an auction. In such embodiments, for example, the host device 120 is configured to manage the auction. As such, the host device 120 can send data to and receive data from the communication devices 180 associated with the auction. For example, as described in further detail herein, the host device 120 can send data associated with a state of the auction (e.g., a price of an item, the time left in the auction, etc.) to the communication devices 180. Additionally, the host device 120 can send user specific data (e.g., the number of bids a user has used in the auction, a listing of auctions the user is monitoring, a listing of auctions the user might be interested in based on past bidding or a user profile, etc.) associated with a user of the communication device 150 (or communication device 160). In some embodiments, the host device 120 can receive data from the communication devices 180 pertaining to the auction. For example, the host device can receive an indication that a user wishes to bid on an item in an auction, the user wishes to purchase an item they previously bid on but did not win, the user wishes to logon to their account, and/or the like.

In some embodiments, the memory 124 of the host device 120 acts as a data repository. In such embodiments, the data associated with the auctions (auction price, auction time, data pertaining to an individual user, statistical data, and/or the like) is stored in the memory 124 of the host device 120. When a user wishes to view data associated with a specific auction and/or a user profile, the host device 120 can send the data to the user when a signal requesting the data is received from a communication device.

Further, in some embodiments, the memory 124 of the host device 120 stores account information associated with the users. In such embodiments, for example, the host device 120 can store a username and password associated with a user, preferences associated with the user, a listing of auctions participated in by the user, a listing of the auctions the user won, a number of the user's unused bids, and/or the like.

Each of the communication devices 180 can be, for example, a computing entity (e.g., a personal computing device such as a desktop computer, a laptop computer, etc.), a mobile phone, a monitoring device, a personal digital assistant (PDA), and/or so forth. Although not shown, in some embodiments, each of the communication devices 180 can include one or more network interface devices (e.g., a network interface card) configured to connect the communication devices 180 to the network 170. In some embodiments, the communication devices 180 can be referred to as client devices.

As shown in FIG. 1, the communication device 160 has a processor 162, a memory 164, and a display 166. The memory 164 can be, for example, a random access memory (RAM), a memory buffer, a hard drive, and/or so forth. The display 166 can be any suitable display, such as, for example, a liquid crystal display (LCD), a cathode ray tube display (CRT) or the like. Similar to communication device 160, the communication device 150 has a processor 152, a memory 154, and a display 156.

In some embodiments, a web browser application can be stored in the memory 164 of the communication device 160. Using the web browser application, the communication device 160 can send data to and receive data from the host device 120. Similarly, the communication device 150 can include a web browser application. In such embodiments, the communication devices 180 act as thin clients. This allows minimal data to be stored on the communication devices 180. In other embodiments, the communication devices 180 can include an application specific to communicating with the host device 120 during auctions. In such embodiments, the communication devices 180 can download the application from the host device 120 prior to participating in an auction.

As discussed above, the communication devices 180 can send data to and receive data from the host device 120 associated with an auction. In some embodiments, the data sent between the communication devices 180 and the host device 120 can be formatted using any suitable format. In some embodiments, for example, the data can be formatted using extensible markup language (XML), hypertext markup language (HTML) and/or the like.

In some embodiments, one or more portions of the host device 120 and/or one or more portions of the communication devices 180 can include a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with the host device 120 (e.g., the functions associated with the processor 122) can be included in one or more modules. In some embodiments, one or more of the functions associated with the communication devices 180 (e.g., functions associated with processor 152 or processor 162) can be included in one or more modules. In some embodiments, one or more of the communication devices 180 can be configured to perform one or more functions associated with the host device 120, and vice versa.

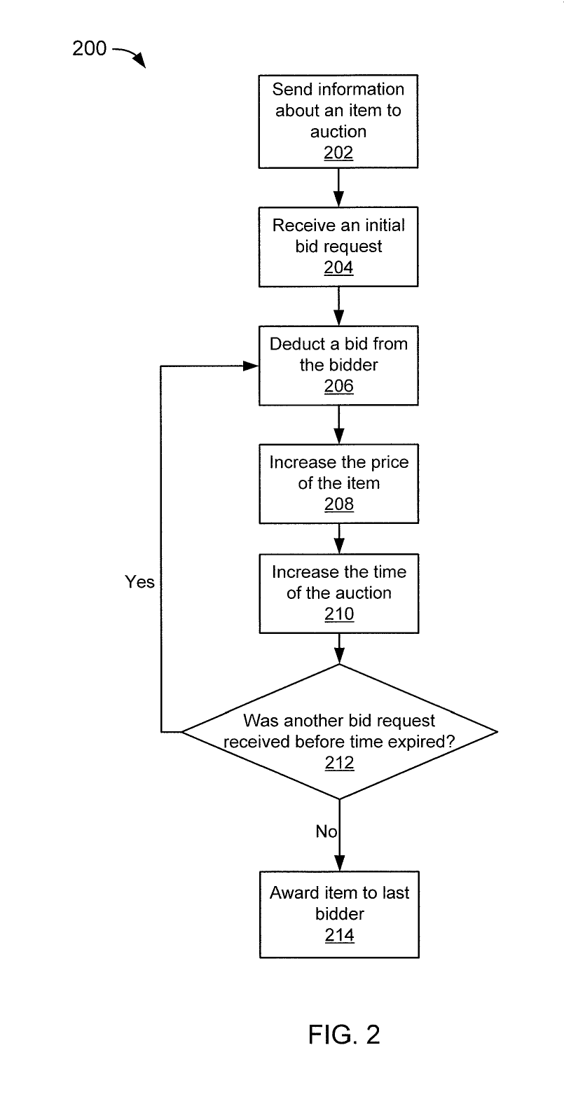

FIG. 2 is a flow chart illustrating a method 200 of managing an auction, according to another embodiment. Initially, information associated with an auction is sent to one or more communication devices, at 202. For example, a host device (e.g., host device 120) can send information about an item to be auctioned to the communication devices (e.g., communication devices 180). In some embodiments, the information can be sent to a communication device in response to a request for the information made by the communication device. For example, the host device can publish the information to a website accessible by the communication device. When the communication device requests access to the website, the host device can send the information associated with the auction to the communication device. In such embodiments, a user of the communication device can view the information associated with the auction over the Internet. In other embodiments, the communication device can view the information associated with the auction over any other suitable network, such as, for example, an intranet, a local area network (LAN) or the like.

In some embodiments, the information associated with the auction can include, for example, details about an item to be auctioned (e.g., a description of the item, a photograph of the item, a retail price of the item, etc.), a current price of the auction, a number of bids received in the auction, a minimum price for the item, an identifier of the user who last bid in the auction, a time remaining in the auction, a discounted price of the item based on the number of bids a user has used on the item, and/or the like.

An initial bid request is received, at 204. The host device can receive the initial bid request from, for example, a communication device. More particularly, a user of a communication device can cause the communication device to send a signal to the host device indicating the user's intent to bid in the auction.

In some embodiments, prior to bidding on an item in an auction, a user can purchase a number of bids. Each bid allows a user to bid in an auction. Said another way, purchasing a bid gives the user the right to bid on an item in an auction. Each time a user bids in an auction, they use a bid. As such, in response to receiving the initial bid request, at 204, a bid is deducted from the bidder (i.e., the user making the initial bid), at 206. As described in further detail herein, in other embodiments, a user does not purchase the bid in advance and pays for the bid when the bid is placed in the auction. Thus, instead of deducting a bid from the bidder, the host device charges the bidder a price each time the bidder places a bid in an auction.

Additionally, in response to receiving the initial bid request, at 204, the price of the item in the auction is increased, at 208. In some embodiments, the price of the item is increased by a predetermined amount. In such embodiments, for example, each time a bid is received from a user, the price of the item is increased by the same amount. In some embodiments, for example, each time a bid request is received from a communication device, the host device increases the price of the auction by $0.50. In other embodiments, the price of the auction can be increased by any amount in response to receiving a bid. In still other embodiments, the user bidding on the item can choose how much to increase the price of the auction.

In response to receiving the initial bid request, at 204, the time of the auction is also increased, at 210. Said another way, the duration of the auction can be increased in response to receiving an indication that a user has used a bid in the auction. In some embodiments, whenever a bid request is received, the duration of the auction is reset to an amount of time. For example, each time a bid request is received, the duration of the auction can be reset to 15 seconds. Thus, if a bid request is received with 7 seconds remaining in the auction, the duration of the auction can be reset to 15 seconds. Similarly, if a bid request is received with 1 second remaining in the auction, the duration of the auction can be reset to 15 seconds. In such embodiments, if the time remaining in the auction is greater than the amount to be reset to (e.g., 15 seconds in the current example), the amount of time remaining in the auction is not changed. Thus, in the current example, if the amount of time remaining in the auction is 30 seconds when a bid is received, the amount of time remaining in the auction remains at 30 seconds because the amount of time is greater than 15 seconds. In other embodiments, each time a bid request is received, the duration of the auction can be reset to any suitable amount of time.

In still other embodiments, a predetermined amount of time can be added to the auction when a bid request is received. For example, each time a bid request is received, 10 seconds can be added to the duration of the auction. Thus, if a bid request is received with 7 seconds remaining in the auction, the duration of the auction can be reset to 17 seconds. Similarly, if a bid request is received with 1 second remaining in the auction, the duration of the auction can be reset to 11 seconds. In yet other embodiments, each time a bid request is received, any suitable amount of time can be added to the duration of the auction.

The host device continues to monitor the auction to determine whether another bid request is received before the time of the auction expires, at 212. If another bid is received, the host device returns to step 206 to deduct a bid from the subsequent bidder, at 206, increase the price of the item, at 208, and increase the time of the auction, at 210. Thus, the auction continues until the bidders stop bidding before the time of the auction expires.

If the host device does not receive a subsequent bid request before the time of the auction expires, the item in the auction is awarded to the last bidder, at 214 for the current auction price of the item. Accordingly, the winner of the auction pays the current price of the item in the auction.

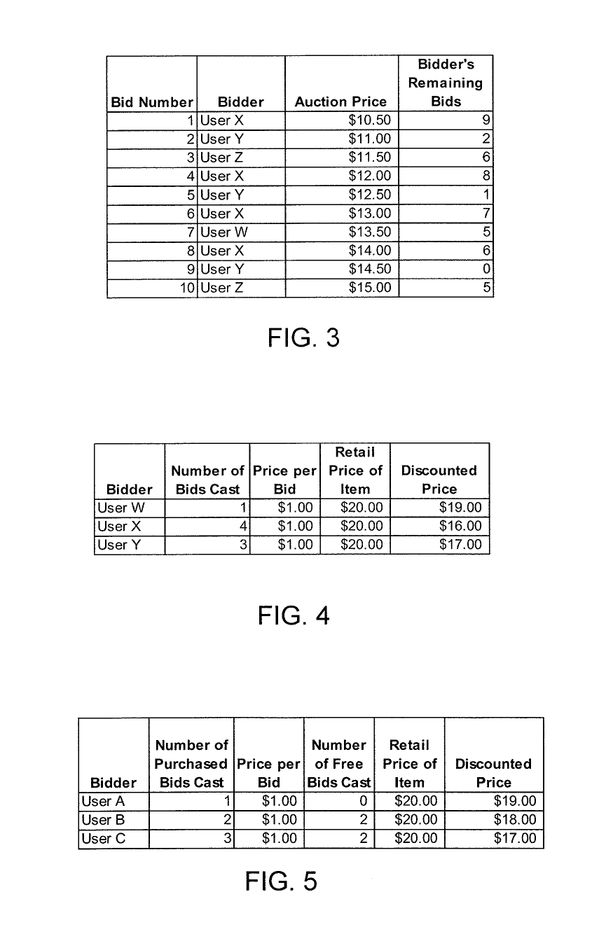

In some embodiments, the host device provides an option to users who were not awarded the item to purchase a substantially similar item (e.g., a different instance of the same type of item) for a discounted price. For example, if the item in the auction is a computer, the substantially similar item can be another instance of the same model of computer. In some embodiments, the discounted price can be a predetermined retail price of the item discounted by the amount of money the user used to place bids in the auction. FIGS. 3 and 4 are tables illustrating an example of purchasing a substantially similar item as an item in an auction at a discount price, according to another embodiment.

FIG. 3 illustrates the history of an auction in which four users (User W, User X, User Y, and User Z) participated. In the current example, prior to the auction, each of the users purchases a number of bids for $1.00 each. For example, User W purchases 6 bids at $1.00 each for a total of $6.00, User X purchases 10 bids at $1.00 each for a total of $10.00, User Y purchases 3 bids at $1.00 each for a total of $3.00, and User Z purchases 7 bids at $1.00 each for a total of $7.00. Accordingly, User W can place a total of 6 bids in the auction, User X can place a total of 10 bids in the auction, User Y can place a total of 3 bids in the auction and user Z can place a total of 7 bids in the auction. In some embodiments, these bids can be used not only in the current auction but can be retained and used in future auctions and/or simultaneously occurring auctions. In other embodiments, each bid can be only used in the current auction.

In the current example, the initial starting price for the auction is $10.00. Each time a bid is placed, the auction price is increased by $0.50 and a bid is deducted from the user who placed the bid. The $10.00 initial starting price ensures that the auctioneer will receive no less than $10.00 for the item.

As shown in FIG. 3, User X places the first bid in the auction. In response to placing the bid, the auction price is increased by $0.50 to $10.50. Additionally, the number of bids that User X has is decreased from 10 to 9. The second bid is placed by User Y. Similar to the first bid, in response to the second bid the auction price is increased by $0.50 to $11.00 and the number of bids that User Y has is decreased from 3 to 2. The auction continues in such a manner until User Z places the tenth bid of the auction. This increases the price by $0.50 to $15.00 and decreases User Z's remaining bids to 5. After User Z's bid, no other bids are received before the time of the auction expires. Accordingly, because User Z was the last user to bid on the item in the auction when the time of the auction expired, the item is awarded to User Z for a price of $15.00.

User W, User X and User Y are provided the opportunity to purchase an item substantially similar to the item won by User Z (e.g., a separate instance of the same product) at a discounted price. As shown in FIG. 4, the discounted price is equal to a retail price of the item minus the price of the bids used in the auction. In the current example, the retail price of the item is determined to be $20.00. User W cast a single bid in the auction. As discussed above, each bid cost $1.00 to purchase. Accordingly, User W can purchase a substantially similar item for $19.00 (retail price of $20.00 minus the cost of the bid $1.00). Similarly, User X cast a total of four bids in the auction. Thus, User X can purchase a substantially similar item for the discounted price of $16.00 (retail price of $20.00 minus the cost of four bids $4.00). Further, User Y cast a total of three bids in the auction and can therefore purchase a substantially similar item for the discounted price of $17.00. Offering substantially similar items at a discount price allows the users who were not awarded the item in the auction a chance to apply the costs of the bids used in the auction to purchasing a substantially similar item.

In some embodiments, a user has a predetermined amount of time after the completion of the auction to determine whether or not to purchase the substantially similar item at the discounted price. In some embodiments, for example, if the host device receives a request to purchase the substantially similar item within one hour from the completion of the auction, the user can purchase the substantially similar item at the discounted price. In other embodiments, the user has twenty-four hours from the completion of the auction to determine whether to purchase the substantially similar item at the discounted price. In still other embodiments, the user can have any amount of time to determine whether to purchase the substantially similar item at the discounted price. In yet other embodiments, the user must determine to purchase the substantially similar item at the discount price before the completion of the auction. In such embodiments, the discounted price can be equal to the predetermined retail price of the item minus the cost of the number of bids used by the user up to that point in the auction.

In some embodiments, free bids can be offered to a user. Such free bids can be offered as a result of a promotion, a rewards program (e.g., if you purchase a given number of bids you get an additional bid free), and/or the like. Similar to purchased bids, the free bids can be used by the user to bid on items in an auction. In some embodiments, however, the free bids used in an auction are not used to discount the price of the auction. An example of this is illustrated in FIG. 5.

FIG. 5 illustrates three users who participated in an auction but were not awarded the item in the auction. User A used 1 purchased bid and no free bids in the auction, User B used 2 purchased bids and 2 free bids in the auction, and User C used 3 purchased bids and 2 free bids in the auction. In the current example, the retail price of the item in the auction is $20.00. Accordingly, User A can purchase a substantially similar item for $19.00 (retail price of $20.00 minus the cost of one purchased bid $1.00), User B can purchase a substantially similar item for $18.00 (retail price of $20.00 minus the cost of two purchased bids $2.00), and User C can purchase a substantially similar item for $17.00 (retail price of $20.00 minus the cost of three purchased bids $3.00). The free bids used by User B and User C in the auction do not affect the discounted price of the substantially similar item.

In other embodiments, the free bids do affect the discounted price of the substantially similar item. In such embodiments, the free bids can be counted to the same extent as a purchased bid or can be counted to a lesser extent than a purchased bid. In some embodiments, for example, if each purchased bid costs $1.00, each free bid used in an auction can discount the substantially similar item by $1.00. In other embodiments, for example, if each purchased bid costs $1.00, each free bid used in an auction can discount the substantially similar item by a percentage of $1.00. In some embodiments, for example, each purchased bid used can discount the price of the substantially similar item by $1.00 and each free bid used can discount the price of the substantially similar item by $0.50.

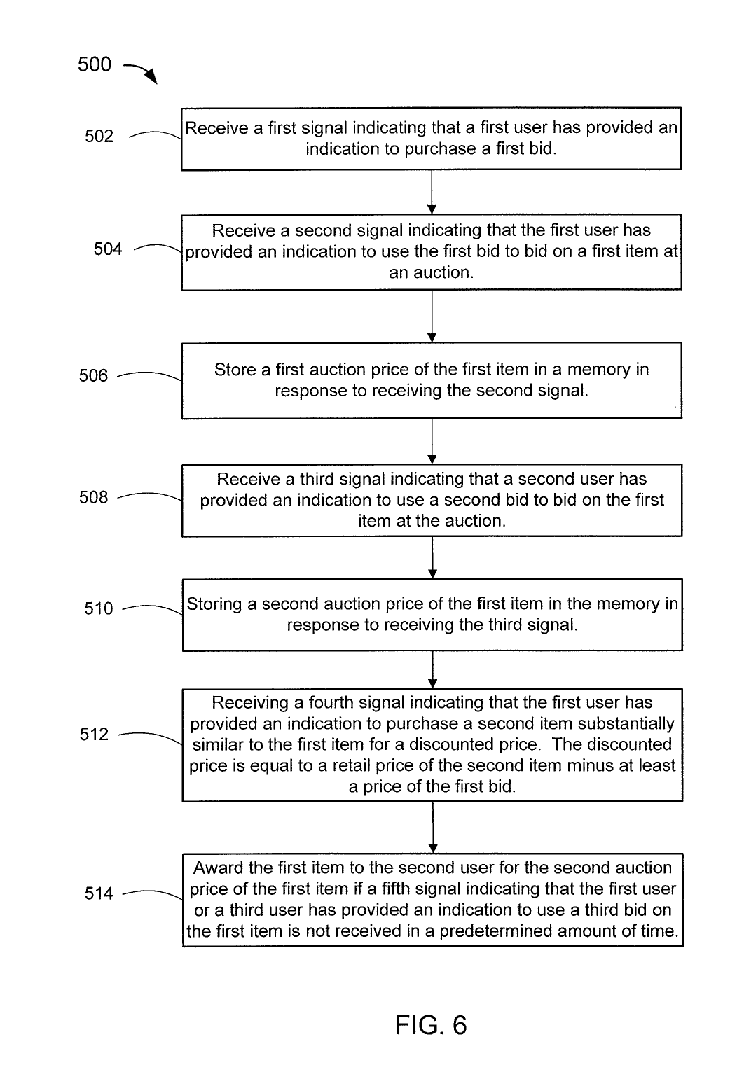

FIG. 6 is a flow chart illustrating a method 500 of managing an auction, according to another embodiment. A first signal indicating that a first user has provided an indication to purchase a first bid is received, at 502. As discussed above, the first user can provide such a signal to a host device (e.g., host device 120 using a communication device (e.g., communication device 150). The first bid can be purchased for a predetermined price. In some embodiments, the first bid can be used in any auction managed by the host device. In other embodiments, the first bid can only be used on a single auction or a subset of auctions managed by the host device.

A second signal indicating that the first user has provided an indication to use the first bid to bid on a first item at an auction is received, at 504. A first auction price of the first item is stored in a memory in response to receiving the second signal, at 506. The first auction price can a result of a predetermined increase of an initial auction price. The increase in the auction price can be a result of receiving the second signal.

A third signal indicating that a second user has provided an indication to use a second bid to bid on the first item at the auction is received, at 508. A second auction price of the first item is stored in the memory in response to receiving the third signal, at 510. The second auction price can be a result of a predetermined increase of the auction price from the first auction price. Accordingly, the second auction price can be greater than the first auction price.

A fourth signal indicating that the first user has provided an indication to purchase a second item substantially similar to the first item for a discounted price is received, at 512. The discounted price is equal to a retail price of the second item minus at least a price of the first bid. The first item is awarded to the second user for the second auction price of the first item if a fifth signal indicating that the first user or a third user has provided an indication to use a third bid on the first item is not received in a predetermined amount of time, at 514.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

While shown above as discounting the price of the substantially similar item by the entire cost of the bids used by a user in an auction, in some embodiments, the substantially similar item is discounted by only a portion of the costs of the bids used. In some embodiments, for example, the substantially similar item is discounted by only half of the costs of the bids used. In such an embodiment, in the example shown in FIGS. 3 and 4, User W's discounted price would be $19.50, User X's discounted price would be $18.00, and User Y's discounted price would be $18.50. In other embodiments, the substantially similar item can be discounted by any percentage and/or portion of the costs of the bids used by a user in an auction.

In some embodiments, the discounted price is not only discounted using the bids cast by a user in a current auction, but the discounted price can be calculated based on a combination of the bids cast by a user in multiple auctions. In such embodiments, for example, if the user participates in three different auctions for three substantially similar items (e.g., three instances of the same product), a fourth substantially similar product made available for purchase by the user can be discounted by the costs of the bids cast in all three auctions. In other embodiments, the multiple auctions need not be substantially similar and the user can aggregate his bids used in multiple unrelated auctions to receive a discount on a product.

In some embodiments, there is a limit on the discount a user who was not awarded an item in an auction can receive when purchasing a substantially similar item. Such a limit can be a dollar amount, a percentage of the retail price of the product, and/or the like. In some embodiments, for example, the discounted price of a substantially similar item offered to a user who was not awarded an item in an auction is at most only a predetermined amount less than a retail price of the item. For example, if the predetermined amount is $10.00 and the user has used $12.00 in bids in the auction, the discounted price presented to the user will be $10.00. In other embodiments, the predetermined amount is based on a percentage of the retail price of the product. In such embodiments, for example, the discounted price of a substantially similar item offered to a user who was not awarded an item in an auction is at most 10% of the retail price of the product. As such, if the retail price of an item is $100, the highest discount that can be received on the product is $10. In other embodiments, any percentage of the retail price of the product can be used as a limit.

While bids are described above as being purchased prior to an auction to be used in the auction, in other embodiments, a bidder pays a fee each time he bids in an auction. This creates a pay-as-you-go system as opposed to paying for the bids up-front. Similar to the embodiments shown and described above, in such embodiments, the discounted price of a substantially similar item offered to a user who was not awarded an item in an auction can be equal to the retail price of the item minus the cost of the bids used in the auction.

While each bid is shown and described above as costing the same amount of money, in other embodiments, the price of each bid can varied based on additional circumstances. In some embodiments, for example, various auctions can be categorized based on the item to be auctioned. For example, some auctions can be classified as premium auctions. Such premium auctions can require bids to be used that cost more than bids for regular auctions. For example, a bid for a premium auction might cost $2.00 while a bid for a regular auction costs $1.00. In other embodiments, the price of casting a bid in the auction can increase as the amount of time left in the auction decreases and/or the amount of bids received in an auction increases. Similarly, in yet other embodiments, the price of casting a bid in the auction can decrease as the amount of time left in the auction decreases and/or the amount of bids received in an auction increases.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate. For example, any of the above described embodiments can limit the discount to a percentage of the retail price of the item and exclude free bids from the calculation of the discount.

What is claimed is:

1. A processor-readable medium storing code representing instructions configured to cause a processor to:
receive a first signal indicating that a first user has used a first bid to bid on a first item at an auction;
increase an auction price of the first item in response to receiving the first signal;
receive a second signal indicating that a second user has used a second bid to bid on the first item at the auction;
increase the auction price of the first item in response to receiving the second signal; and
receive a third signal indicating that the first user has chosen to purchase a second item substantially similar to the first item for a discounted price, the discounted price being equal to a retail price of the second item minus at least a price of the first bid.

2. The processor-readable medium of claim 1, wherein the code representing instructions configured to cause the processor to increase the auction price of the first item at the auction in response to receiving the first signal includes code representing instructions configured to cause the processor to increase the price of the first item at the auction by a predetermined amount.

3. The processor-readable medium of claim 1, the code further comprising code representing instructions configured to cause a processor to:
increase a duration of the auction in response to receiving the first signal.

4. The processor-readable medium of claim 1, the code further comprising code representing instructions configured to cause a processor to:
increase a duration of the auction by a predetermined amount of time in response to receiving the first signal; and
increase the duration of the auction by the predetermined amount of time in response to receiving the second signal.

5. The processor-readable medium of claim 1, the code further comprising code representing instructions configured to cause a processor to:
reset a duration of the auction to a predetermined amount of time in response to receiving the first signal; and
reset the duration of the auction to the predetermined amount of time in response to receiving the second signal.

6. The processor-readable medium of claim 1, the code further comprising code representing instructions configured to cause a processor to:
award the first item to the second user for the auction price of the first item if a fourth signal indicating that the first user or a third user has used a third bid to bid on the first item at the auction is not received within a predetermined amount of time.

7. The processor-readable medium of claim 1, wherein the retail price of the second item is a predetermined price of the second item.

8. The processor-readable medium of claim 1, the code further comprising code representing instructions configured to cause a processor to:
receive a fourth signal indicating that the first user has purchased the first bid.

9. The processor-readable medium of claim 1, the code further comprising code representing instructions configured to cause a processor to:
receive a fourth signal indicating that the first user has used a third bid to bid on the first item at the auction, the discounted price of the second item being equal to the retail price of the second item minus at least a price of the first bid and a price of the third bid.

10. The processor-readable medium of claim 1, wherein the price of the first bid is equal to the price of the second bid.

11. The processor-readable medium of claim 1, wherein the first bid is a first type of bid, the code further comprising code representing instructions configured to cause a processor to:
receive a fourth signal indicating that a first user has used a second type of bid to bid on the first item at the auction, the bid from the second type of bid not affecting the discounted price of the first item.

12. A processor-readable medium storing code representing instructions configured to cause a processor to:
receive a first signal indicating that a user has purchased a plurality of bids, each bid from the plurality of bids having a price;
receive a plurality of second signals, each signal from the plurality of second signals indicating that the user has used a bid from the plurality of bids to bid on a first item at an auction; and
receive a third signal indicating that the user has chosen to purchase a second item substantially similar to the first item for a discounted price, the discounted price being equal to a retail price of the second item minus a collective price of the total number of bids from the plurality of bids used by the user to bid on the item in the auction.

13. The processor-readable medium of claim 12, the code further comprising code representing instructions configured to cause a processor to:
increase a duration of the auction in response to receiving a signal from the plurality of second signals.

14. The processor-readable medium of claim 12, the code further comprising code representing instructions configured to cause a processor to:
reset a duration of the auction to a predetermined amount of time in response to receiving a signal from the plurality of second signals.

15. The processor-readable medium of claim 12, wherein the user is a first user and the plurality of bids is a first plurality of bids, the code further comprising code representing instructions configured to cause a processor to:
increase an auction price of the first item a predetermined amount in response to receiving each signal from the plurality of second signals;
receive a plurality of fourth signals, each signal from the plurality of fourth signals indicating that a second user has used a bid from a second plurality of bids to bid on the first item at the auction; and
increase the auction price of the first item the predetermined amount in response to receiving each signal from the plurality of fourth signals.

16. The processor-readable medium of claim 12, wherein the retail price of the second item is a predetermined price of the second item.

17. The processor-readable medium of claim 12, the code further comprising code representing instructions configured to cause a processor to:
increase an auction price of the first item a predetermined amount in response to receiving each signal from the plurality of second signals.

18. The processor-readable medium of claim 12, wherein each bid from the plurality of bids are a first type of bid, the code further comprising code representing instructions configured to cause a processor to:
receive a plurality of fourth signals, each signal from the plurality of fourth signals indicating that the user has used a bid from a plurality of second type of bids to bid on the first item at an auction, the plurality of second type of bids not affecting the discounted price of the first item.

19. A method, comprising:
receiving a first signal indicating that a first user has provided an indication to purchase a first bid;
receiving a second signal indicating that the first user has provided an indication to use the first bid to bid on a first item at an auction;
storing a first auction price of the first item in a memory in response to receiving the second signal;
receiving a third signal indicating that a second user has provided an indication to use a second bid to bid on the first item at the auction;
storing a second auction price of the first item in the memory in response to receiving the third signal;
receiving a fourth signal indicating that the first user has provided an indication to purchase a second item substantially similar to the first item for a discounted price, the discounted price being equal to a retail price of the second item minus at least a price of the first bid; and
awarding the first item to the second user for the second auction price of the first item if a fifth signal indicating that the first user or a third user has provided an indication to use a third bid on the first item is not received in a predetermined amount of time.

20. The method of claim 19, further comprising:
increasing a duration of the auction in response to receiving the second signal.

21. The method of claim 19, further comprising:
increasing a duration of the auction by a predetermined amount of time in response to receiving the second signal; and
increasing the duration of the auction by the predetermined amount of time in response to receiving the third signal.

22. The method of claim 19, further comprising:
resetting a duration of the auction to a predetermined amount of time in response to receiving the second signal; and
resetting the duration of the auction to the predetermined amount of time in response to receiving the third signal.

23. The method of claim 19, further comprising:
increasing the first auction price of the first item by a predetermined amount in response to receiving the second signal, the predetermined amount being equal to the difference between the second auction price and the first auction price.

24. The method of claim 19, wherein the price of the first bid is equal to a price of the second bid.
